(19) United States
(12) Patent Application Publication
(10) Pub. No.: US 2011/0280991 A1
(43) Pub. Date: Nov. 17, 2011

(54) FOOD MATERIAL FROM RICE AS RAW MATERIAL, PROCESSED FOOD USING SAME AND METHOD FOR PRODUCTION THEREOF

(75) Inventor: Yasuko Kainuma, Shizuoka (JP)

(73) Assignee: SHIZUOKA PREFECTURE PUBLIC UNIVERSITY CORPORATION, Shizuoka-shi, Shizuoka (JP)

(21) Appl. No.: 13/144,860

(22) PCT Filed: Jan. 22, 2010
(86) PCT No.: PCT/JP2010/050797

§ 371 Date: Jul. 22, 2011

(30) Foreign Application Priority Data
Jan. 23, 2009 (JP) 2009-012827
Jan. 21, 2010 (JP) 2010-010858

(51) Int. Cl. A23L 1/10; A23L 1/182; A21D 8/04; A21D 13/04

(52) U.S. Cl. 426/21; 426/627; 426/549; 426/507; 426/618

(57) ABSTRACT

Rice grains are soaked in water to give a rice-grain soaked liquid to allow the rice grains to absorb water and the entire rice-grain soaked liquid is then charged into a mill to mill the rice grains to prepare finely-divided rice grains containing water absorbed therein and the finely-divided rice grains form a rice paste containing free water present therebetween; the finely-divided rice grains in the rice paste can be fine; and, in addition, since free water is involved upon milling, deterioration of components by heat can be avoided. In addition, the finely-divided rice grains can remain in a water-absorbed state, and damage of finely-divided rice grains (starch simple grains) by drying can be avoided. In addition, since free water increases affinity between a kneaded product of a different kind of cereal flour or other ingredients and the rice paste, mixing thereof can be rapidly carried out.

### TECHNICAL FIELD

The present invention relates to a food material from rice as raw material, and a processed food using the food material such as bread, and a method for production of the food material and the processed food.

### BACKGROUND ART

While Japan's food self-sufficiency rate is low, the self-sufficiency rate for rice is substantially 100%. Recently, however, a situation of so-called rice glut occurs due to a reduction of consumption, and thus the further expansion of applications of rice has been sought.

On the other hand, since the yield of wheat has significantly reduced due to global climate change and also since there is speculation in the field of commodity transaction, the price of wheat has been increasing.

As a result of a combination of these situations, rice flour is considered as a substitute raw material for wheat flour, and an attempt is being made for substitution in bread, noodles and the like (for example, see Patent Literatures 1 and 2).

As for products from this attempt, however, cost is not necessarily properly kept down, and these products have not yet been widespread in the market.

The reason is that, in the case of rice flour, although the market price of rice as a raw material is certainly low, rice flour becomes accordingly expensive raw material, due to processing cost for milling rice grains. A technical factor that is an obstacle to a reduction in cost of milling rice grains lies in the fact that rice grains themselves are originally very hard. That is to say, endosperm portions of rice grains which are originally ate in the form of grains are very hard and unlikely to become fine powder. Thus, although milling requires powerful force, efficient milling processing cannot be carried out, in order to avoid deterioration of components by heat generated during milling.

As a method to resolve the technical factor that is an obstacle to a reduction in cost of milling rice grains described above, a method of wet flour milling of rice grains together with water is worked out (for example, see Patent Literature 3). However, such a method is a method for obtaining rice flour as a raw material of rice crackers, dumplings, rice-cake sweets and the like, but the use as a substitute raw material for wheat flour is not considered. In addition, in view of this technical idea, the product as a ultimate goal is consistently dry powder, of which moisture needs to be removed for drying after milling to obtain powder, but neither the moisture has been actively utilized nor the action has been strictly ascertained.

### CITATION LIST

### Patent Literature

Patent Literature 1: Japanese Patent Laid-Open No. 9-51754

Patent Literature 2: Japanese Patent Publication No. 56-43209

Patent Literature 3: Japanese Patent Publication No. 8-35

### SUMMARY OF INVENTION

### Technical Problem

The present invention was made taking such backgrounds into consideration, and the technical problem is to develop a food material from rice as raw material and a processed food using the raw material and a method for production thereof, which food material can sufficiently substitute for wheat flour as a substitute raw material, taking cost on a commercial level into consideration, reviewing the common technical knowledge that cereal powder should be of course in a dry state upon being processed in production thereof, on the basis of the idea that, regardless of rice grains in a dry state, the food material may be in a form of paste, as long as a particulate state can be accomplished, and on the basis of the idea that the presence of a certain amount of moisture acts very effectively on milling in processing and can effectively acts also on processing and utilization after commercialization.

### Solution to Problem

That is to say, a food material from rice as raw material according to claim 1 is characterized in that rice grains are soaked in water to give a rice-grain soaked liquid to allow the rice grains to absorb water and the entire rice-grain soaked liquid is then charged into a mill to mill the rice grains to prepare finely-divided rice grains containing water absorbed therein and the finely-divided rice grains form a rice paste containing free water present therebetween.

In addition, a food material from rice as raw material according to claim 2 is characterized in that a ratio of the rice grains to water is 1:0.5 to 1.5 by weight, in addition to the above-mentioned requirements according to claim 1.

Furthermore, a food material from rice as raw material according to claim 3 is characterized in that the maximum particle size distribution peak of the finely-divided rice grains which are milled rice grains contained in the rice paste is from 1 to 10 μm, in addition to the above-mentioned requirements according to claim 1 or 2.

In addition, a processed food using a food material from rice as raw material according to claim 4 is characterized in that a rice paste according to claim 1, 2 or 3 is mixed with a different kind of cereal flour and/or other ingredients, further the mixture is shaped appropriately into a state suitable for eating.

In addition, a processed food using a food material from rice as raw material according to claim 5 is characterized in that a rice paste according to claim 1, 2 or 3 is mixed with a different kind of cereal flour and/or other ingredients, further the mixture is shaped appropriately into a state suitable for eating and further heated to become an edible state.

Furthermore, a processed food using a food material from rice as raw material according to claim 6 is characterized in that the different kind of cereal flour is wheat flour and the processed food is bread, in addition to the above-mentioned requirements according to claim 4 or 5.

Furthermore, a processed food using a food material from rice as raw material according to claim 7 is characterized in that a rate of substitution of the finely-divided rice grains for the wheat flour is 10 to 50%, in addition to the above-mentioned requirements according to claim 6.

In addition, a method for production of a food material from rice as raw material according to claim 8 is characterized in that rice grains are soaked in water to give a rice-grain soaked liquid to allow the rice grains to absorb water and the entire rice-grain soaked liquid is then charged into a mill to mill the rice grains to prepare finely-divided rice grains containing water absorbed therein and wherein the finely-divided rice grains form a rice paste containing free water present therebetween.

Furthermore, a method for production of a food material from rice as raw material according to claim 9 is characterized in that a ratio of water for soaking the rice grains to the rice grains is 1:0.5 to 1.5 by weight.

Furthermore, a method for production of a food material from rice as raw material according to claim 10 is characterized in that the rice grains are soaked in the water for 2 hours or more, in addition to the above-mentioned requirements according to claim 8 or 9.

Furthermore, a method for production of a food material from rice as raw material according to claim 11 is characterized in that the milling is carried out with a mill-stone mill, in addition to the above-mentioned requirements according to claim 8, 9 or 10.

In addition, a method for production of a processed food using a food material from rice as raw material according to claim 12 is characterized in that a rice paste according to claim 1, 2 or 3 is kneaded with a different kind of cereal flour and/or other ingredients, and the mixture is appropriately shaped into a state suitable for eating.

In addition, a method for production of a processed food using a food material from rice as raw material according to claim 13 is characterized in that a rice paste according to claim 1, 2 or 3 is kneaded with a different kind of cereal flour and/or other ingredients, and the mixture is appropriately shaped into a state suitable for eating, and further heated to become an edible state.

In addition, a method for production of a processed food using a food material from rice as raw material according to claim 14 is characterized in that a rice paste according to claim 1, 2 or 3, wheat flour, an appropriate amount of yeast added for producing bread dough, and a seasoning are prepared, and the wheat flour, the yeast and the seasoning are first kneaded with water added therein, subsequently the rice paste is added therein and the mixture is kneaded to prepare bread dough, and the bread dough is thereafter baked and puffed to be processed into bread.

In addition a the method for production of a processed food using a food material from rice as raw material according to claim 15 is characterized in that a rate of substitution of the rice paste for the wheat flour is 10 to 50%, in addition to the above-mentioned requirements according to claim 14.

By means of the constitution of the invention according to each of claims, resolution of the above-mentioned problems is attempted.

### Advantageous Effects of Invention

First, according to the invention according to claim 1, since free water is involved with a starch aggregate which has become in a free state by destruction of starch cells by an action of a crusher so that fluidity is imparted to the starch aggregate, ultrafine finely-divided rice grains can be obtained by disrupting the starch aggregate into starch simple grains, which are minimum units.

In addition, since free water is involved upon milling, deterioration of components of finely-divided rice grains by heat can be prevented.

Furthermore, since the rice paste is in a state containing free water among the finely-divided rice grains containing water absorbed therein, the finely-divided rice grains can remain in a water-absorption state, and damage of the finely-divided rice grains (starch simple grains) by drying can be avoided.

Furthermore, since free water increases affinity between a kneaded product of a different kind of cereal flour or other ingredients and the rice paste, mixing thereof can be rapidly carried out.

In addition, according to the invention according to claim 2, viscosity of the rice paste can be made easily handled. In addition, water required for gelatinization of rice starch can be ensured.

In addition, according to the invention according to claim 3, texture of a processed food using the rice paste can be mild. In addition, binding of the finely-divided rice grains to gluten can be successfully carried out.

In addition, according to the invention according to claim 4, the cost of the processed food can be kept down. In addition, a processed food having novel deliciousness can be provided.

In addition, according to the invention according to claim 5, the cost of the processed food can be kept down. In addition, a processed food having novel deliciousness can be provided.

In addition, according to the invention according to claim 6, the cost of bread can be kept down by reducing a rate of wheat flour used. In addition, bread having novel deliciousness can be provided.

In addition, according to the invention according to claim 7, a puffing state, texture and the like of bread wherein the rice paste is mixed can be good.

In addition, according to the invention according to claim 8, since free water is involved with a starch aggregate which has become in a free state by destruction of starch cells by an action of a crusher so that fluidity is imparted to the starch aggregate, ultrafine finely-divided rice grains can be obtained by disrupting the starch aggregate into starch simple grains, which are minimum units.

In addition, since free water is involved upon milling, deterioration of components of finely-divided rice grains by heat can be prevented.

Furthermore, since the rice paste is in a state containing free water among the finely-divided rice grains containing water absorbed therein, the finely-divided rice grains can remain in a water-absorption state, and damage of the finely-divided rice grains (starch simple grains) by drying can be avoided.

Furthermore, since free water increases affinity between a kneaded product of a different kind of cereal flour or other ingredients and the rice paste, mixing thereof can be rapidly carried out.

In addition, according to the invention according to claim 9, a rice paste having viscosity easy to handle can be produced. In addition, water required for gelatinization of rice starch can be ensured.

In addition, according to the invention according to claim 10, permeation of water into rice grains can be sufficient, and milling can be successfully carried out.

In addition, according to the invention according to claim 11, milling of rice grains can be appropriately carried out to obtain homogenous finely-divided rice grains.

In addition, according to the invention according to claim 12, the cost of the processed food can be kept down. In addition, a processed food having novel deliciousness can be provided.

In addition, according to the invention according to claim 13, the cost of the processed food can be kept down. In addition, a processed food having novel deliciousness can be provided.

In addition, according to the invention according to claim 14, the cost of bread can be kept down by reducing a rate of wheat flour used. In addition, bread having novel deliciousness can be provided. Furthermore, since water required for gelatinization of rice components is previously absorbed by finely-divided rice grains, gluten formation of wheat flour is not affected, and gluten formation is successfully carried out. Furthermore, since the rice paste is rapidly mixed thoroughly and evenly with the wheat flour which has been previously kneaded, binding of rice starch particles to gluten can be successfully carried out.

In addition, according to the invention according to claim 15, a puffing state, texture and the like of bread wherein the rice paste is mixed can be good.

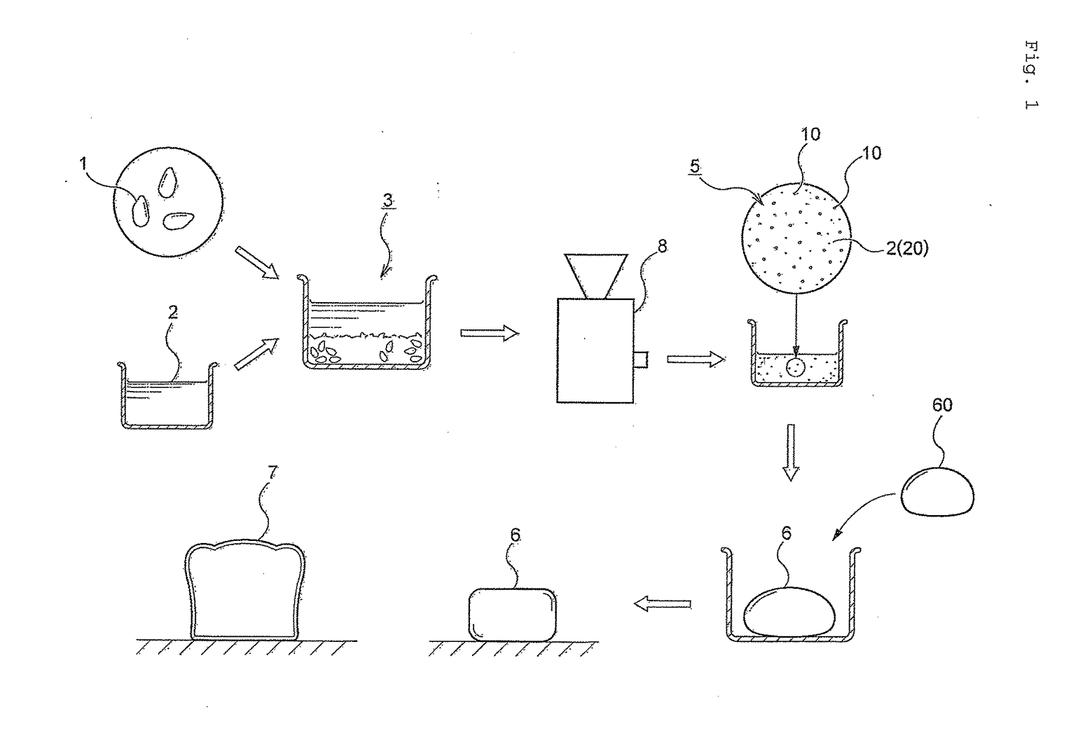

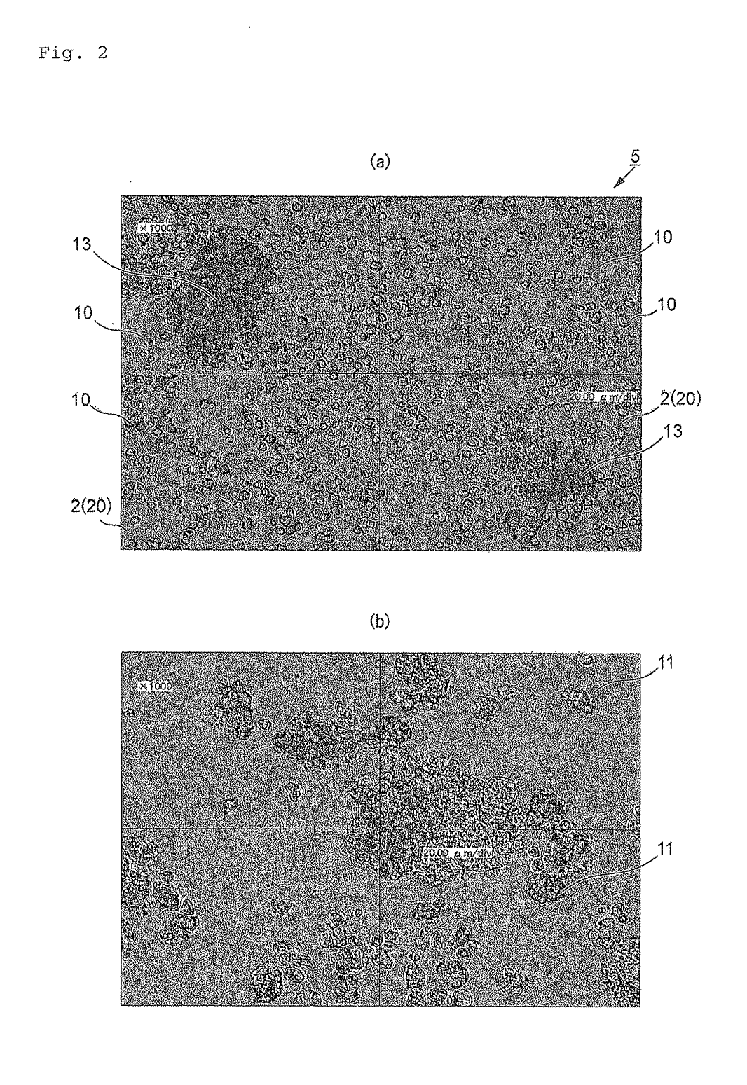

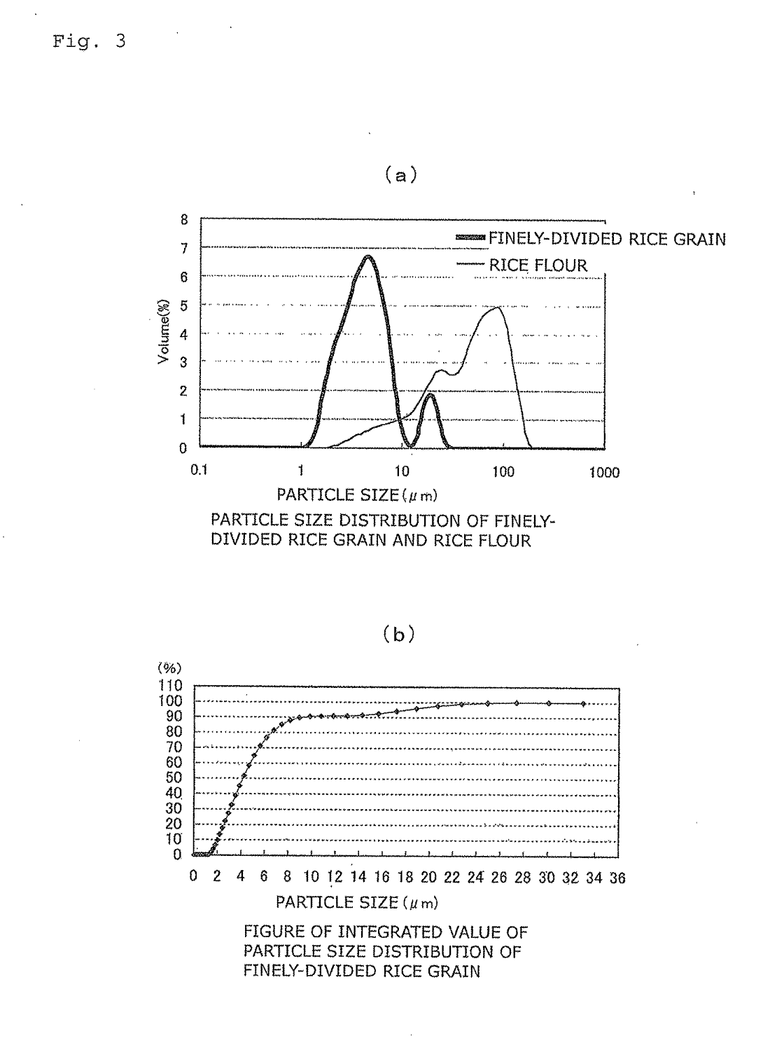

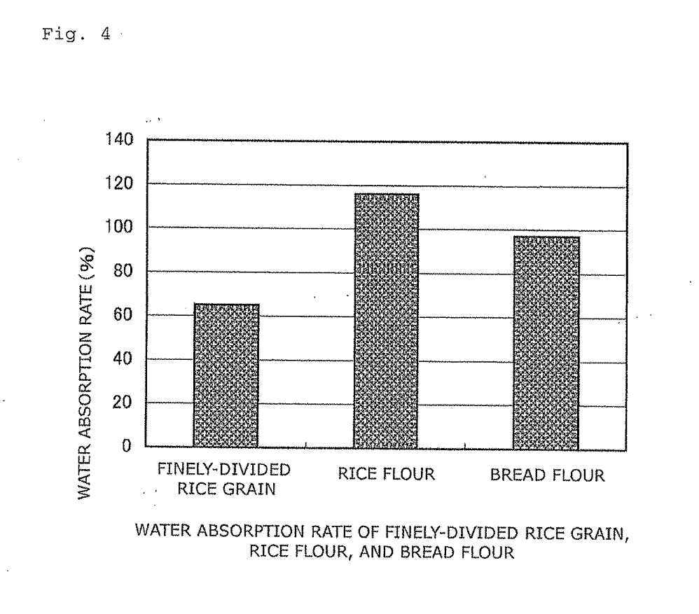

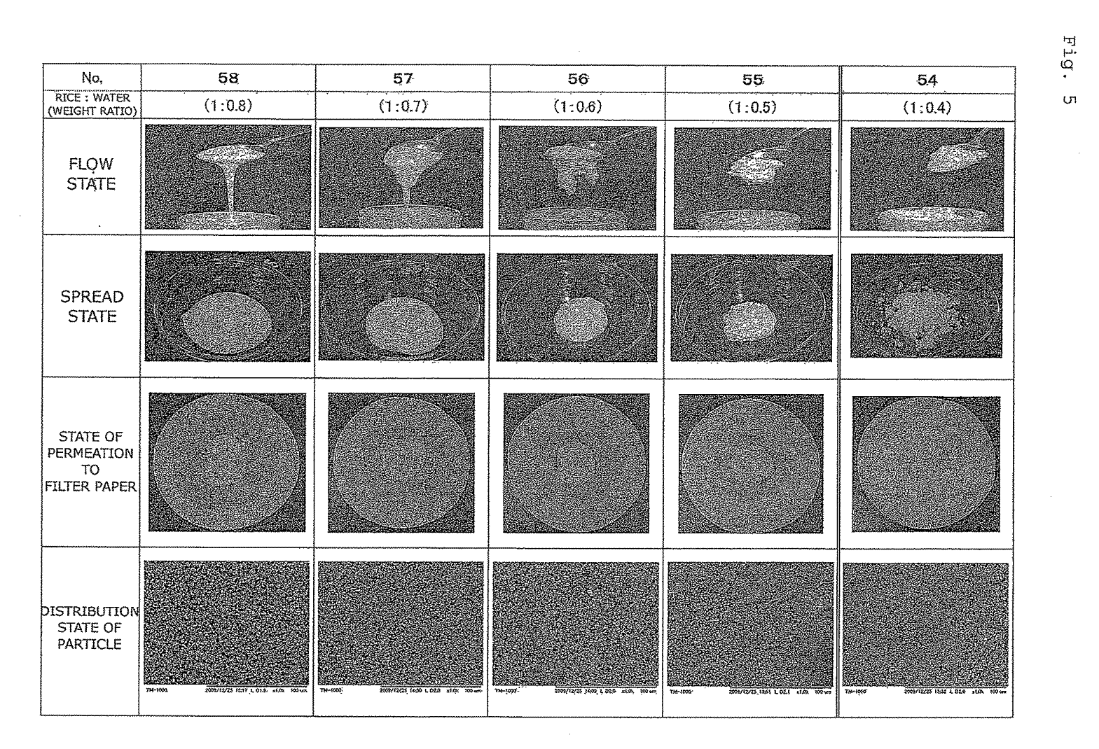

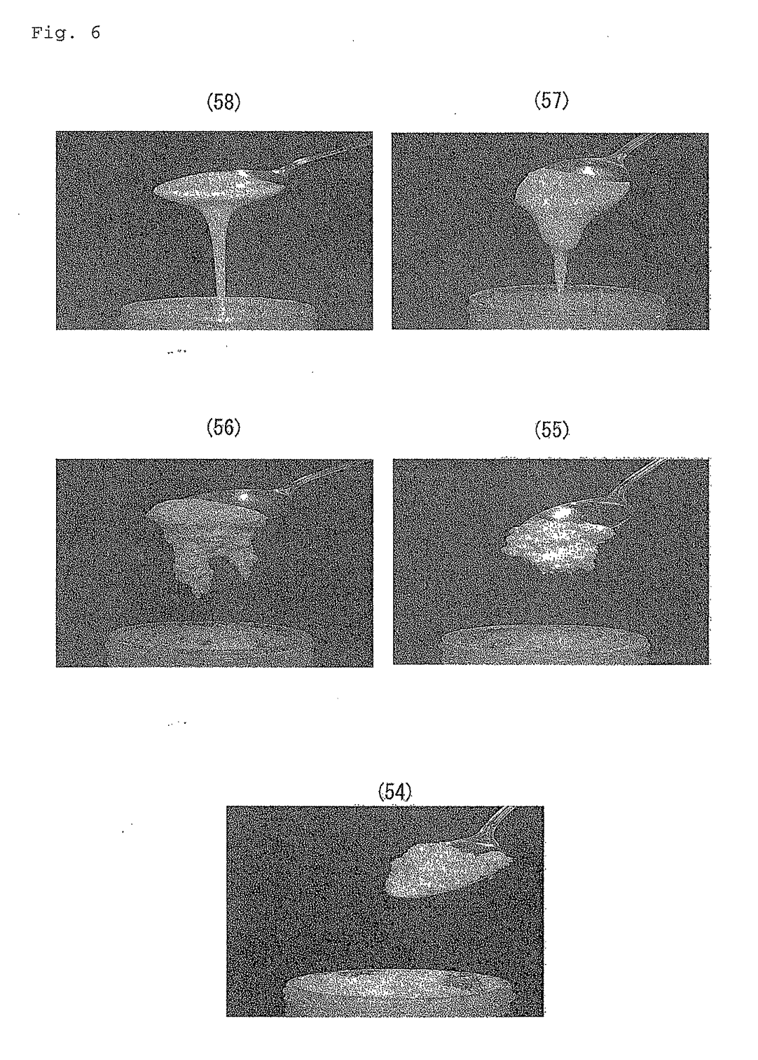

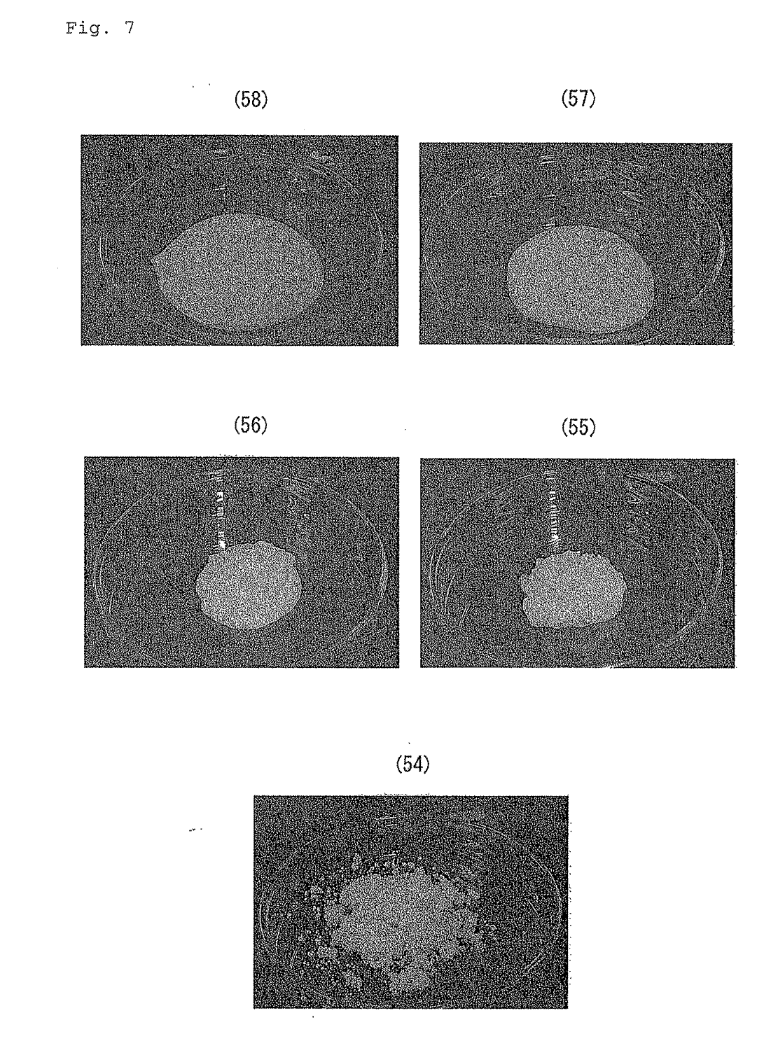

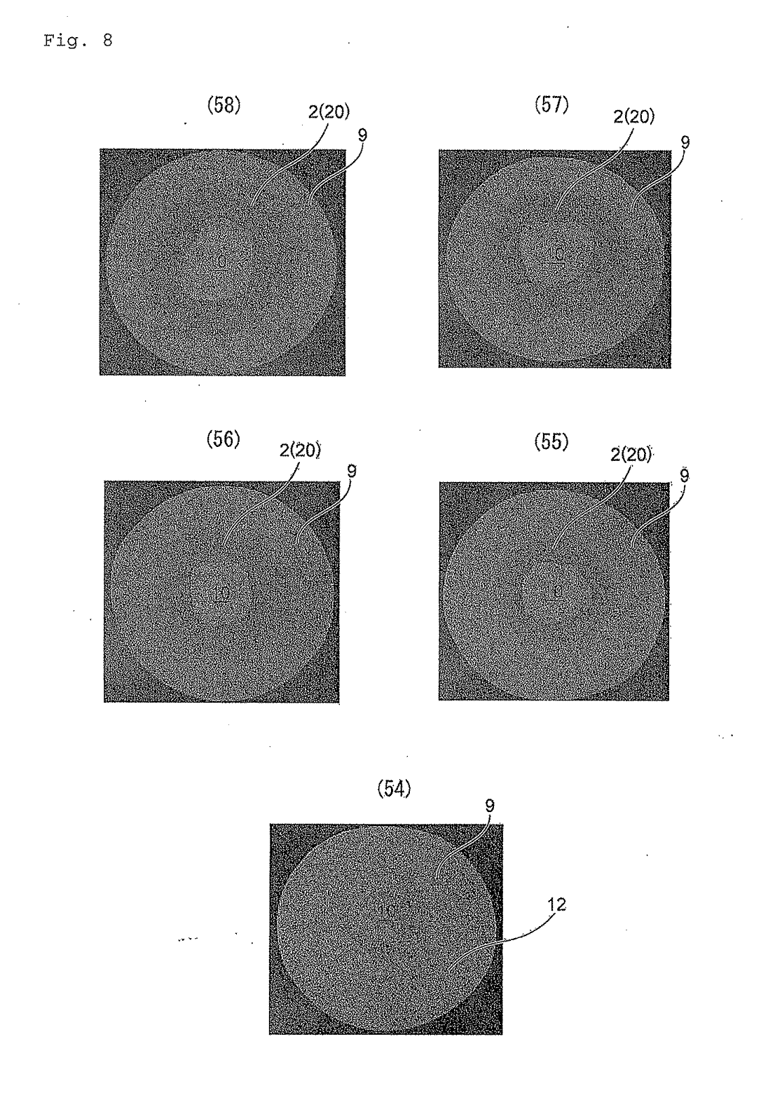

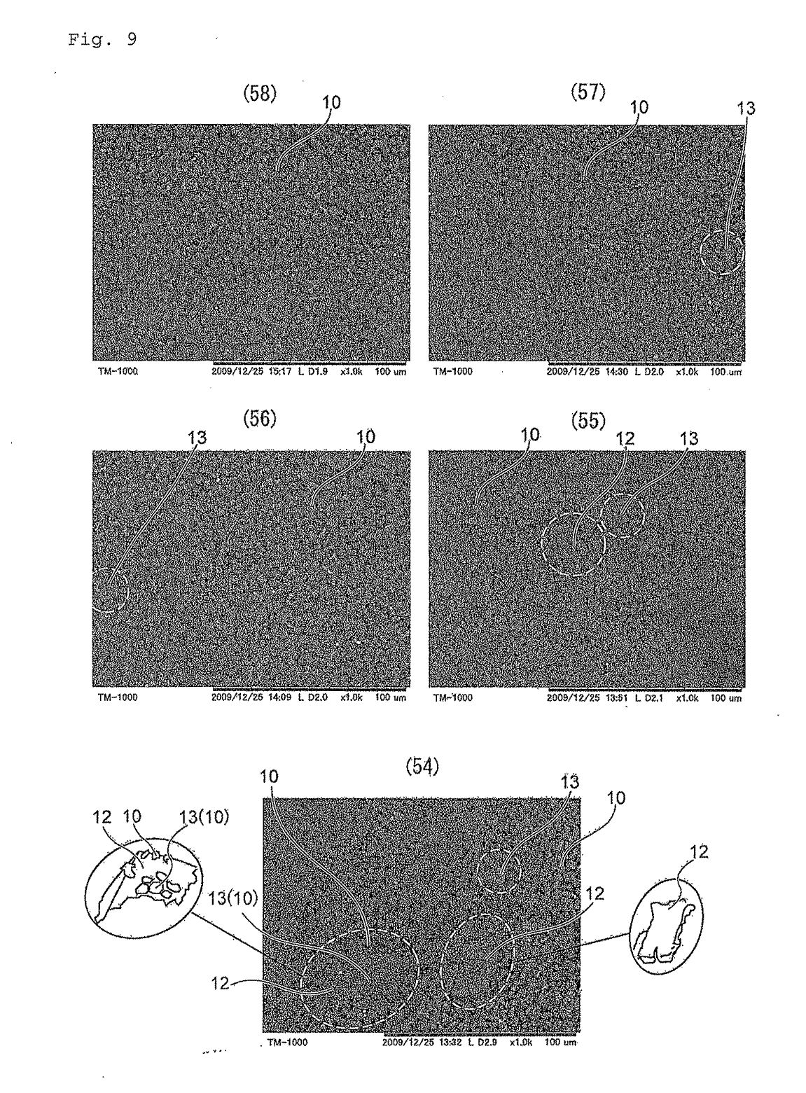

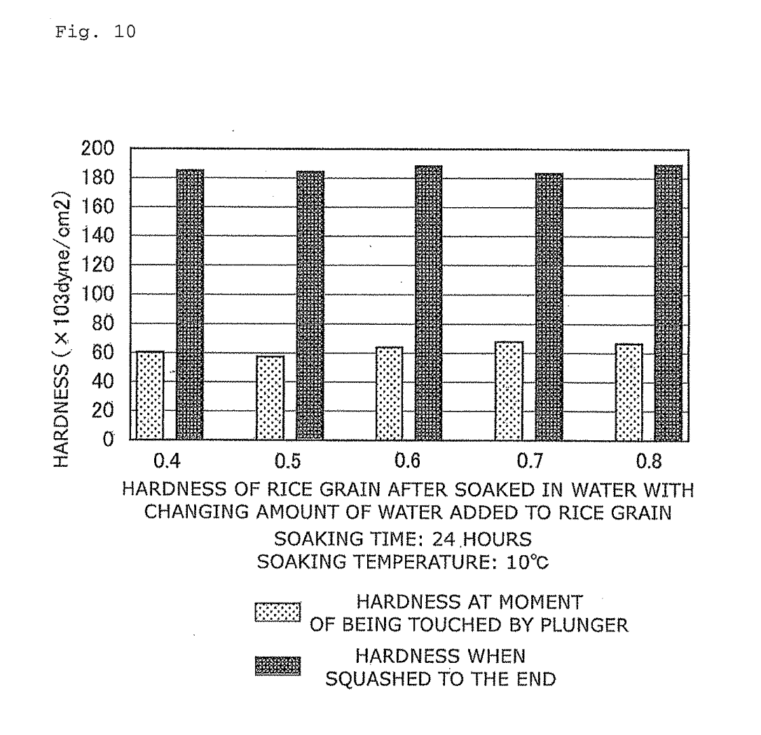

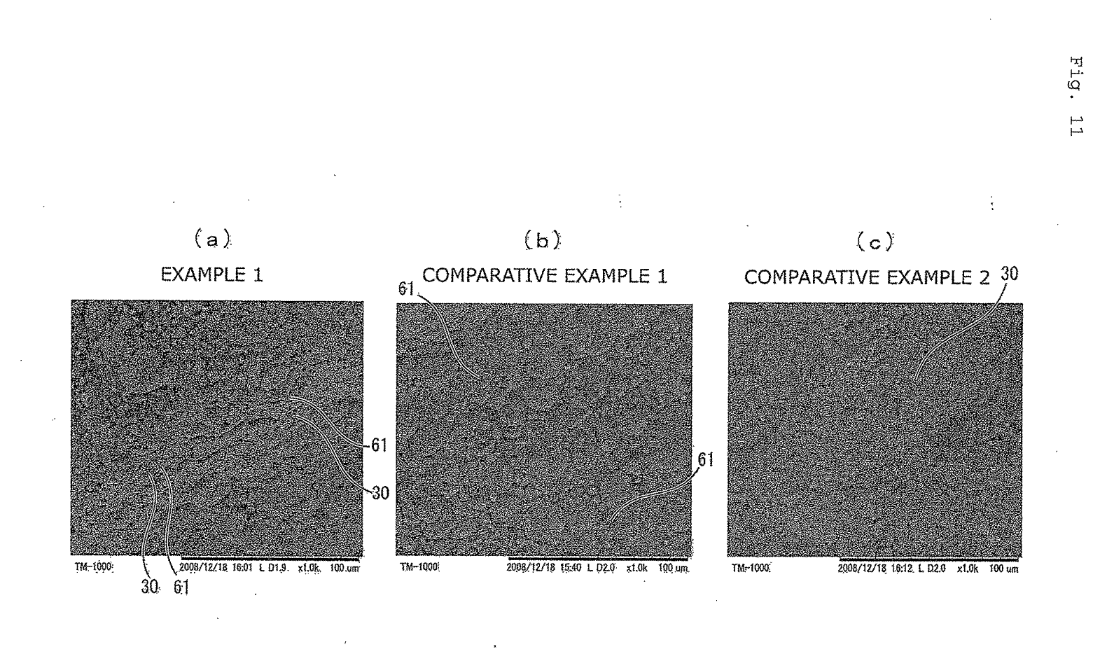

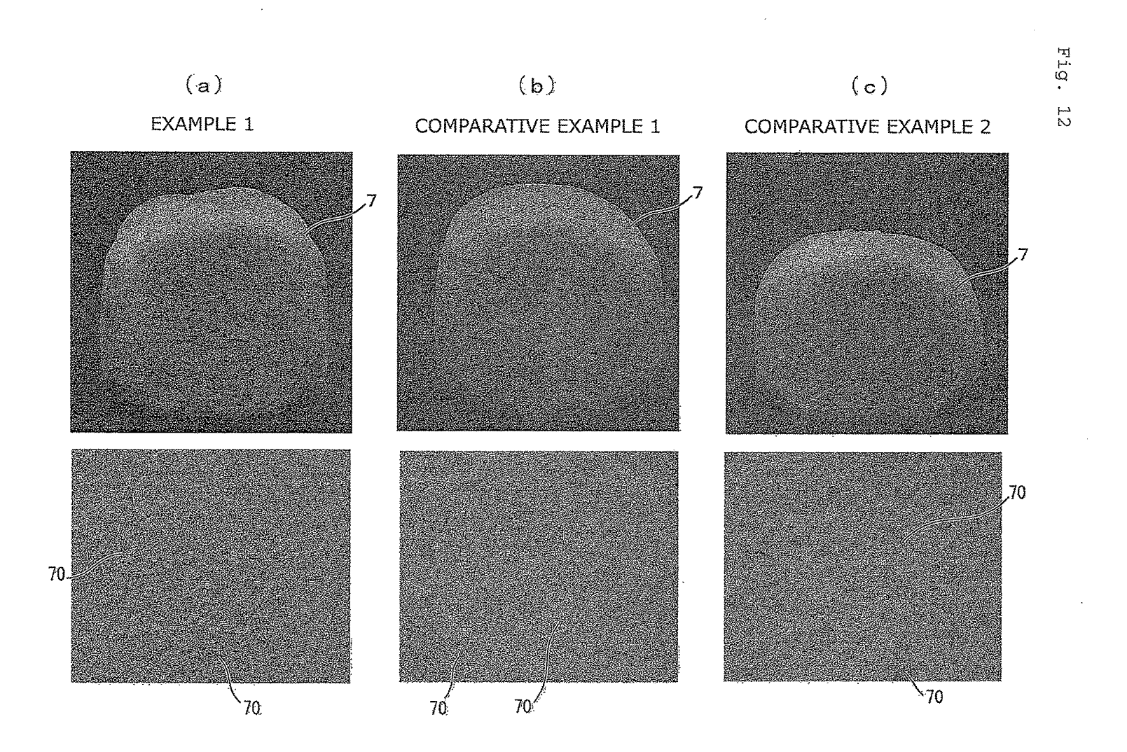

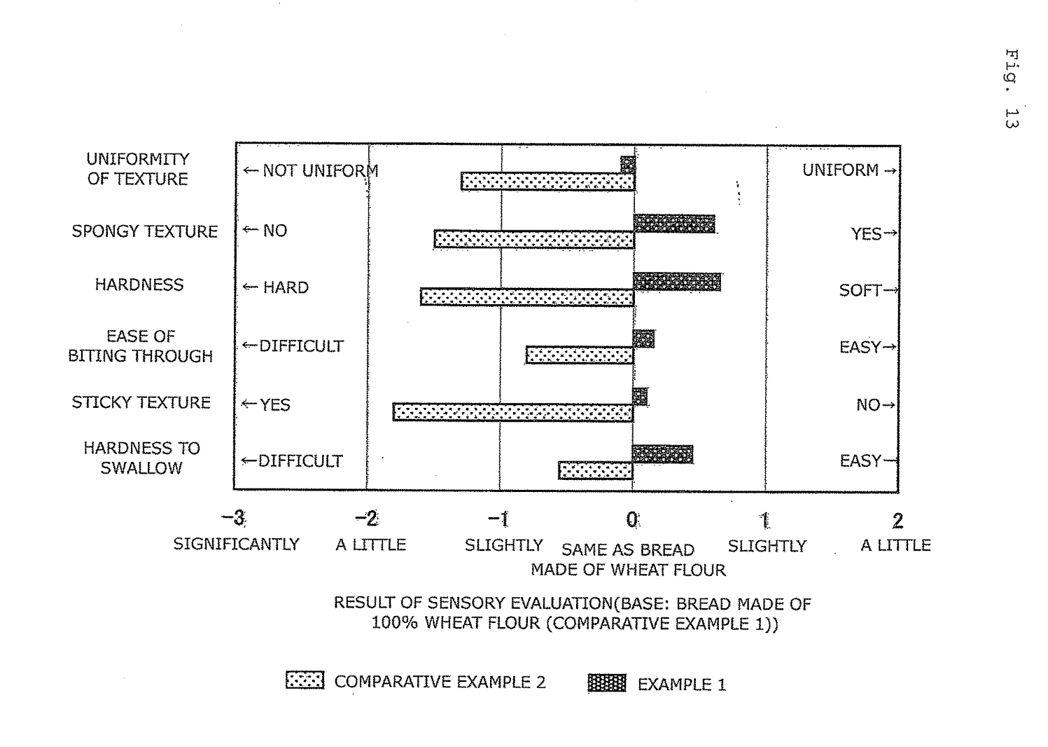

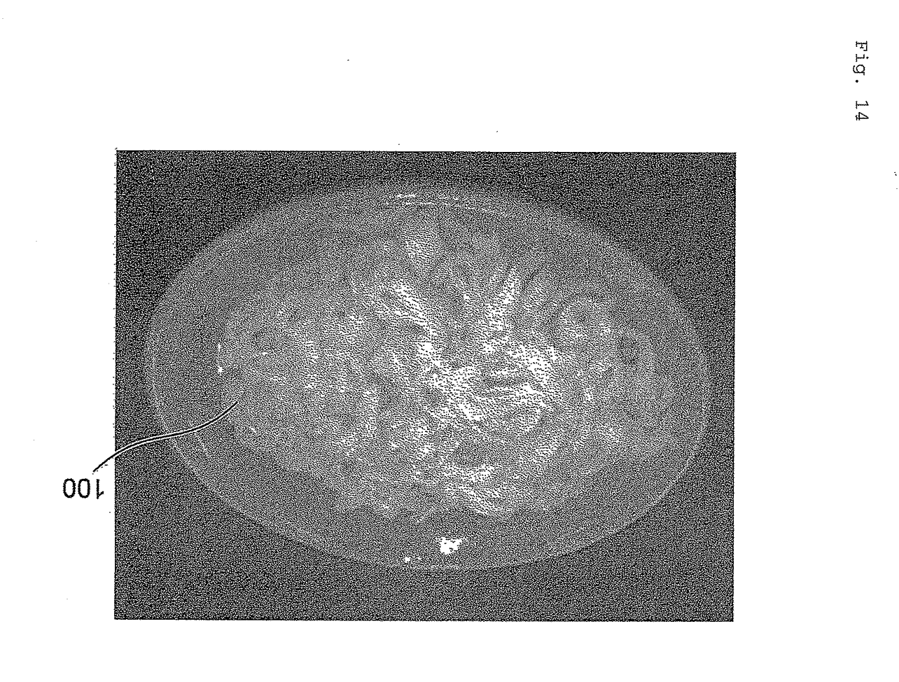

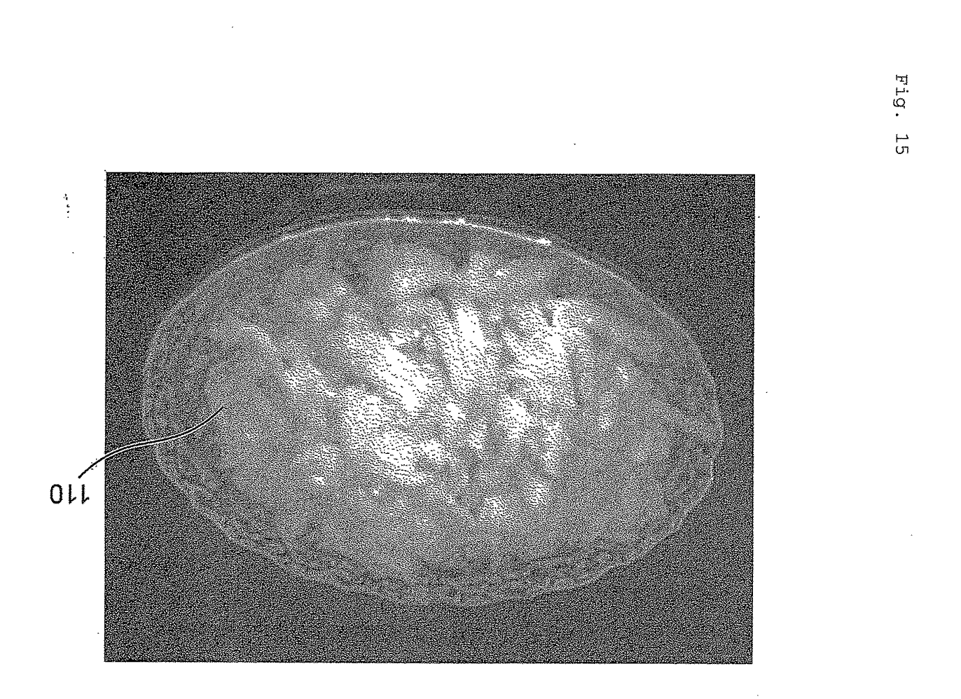

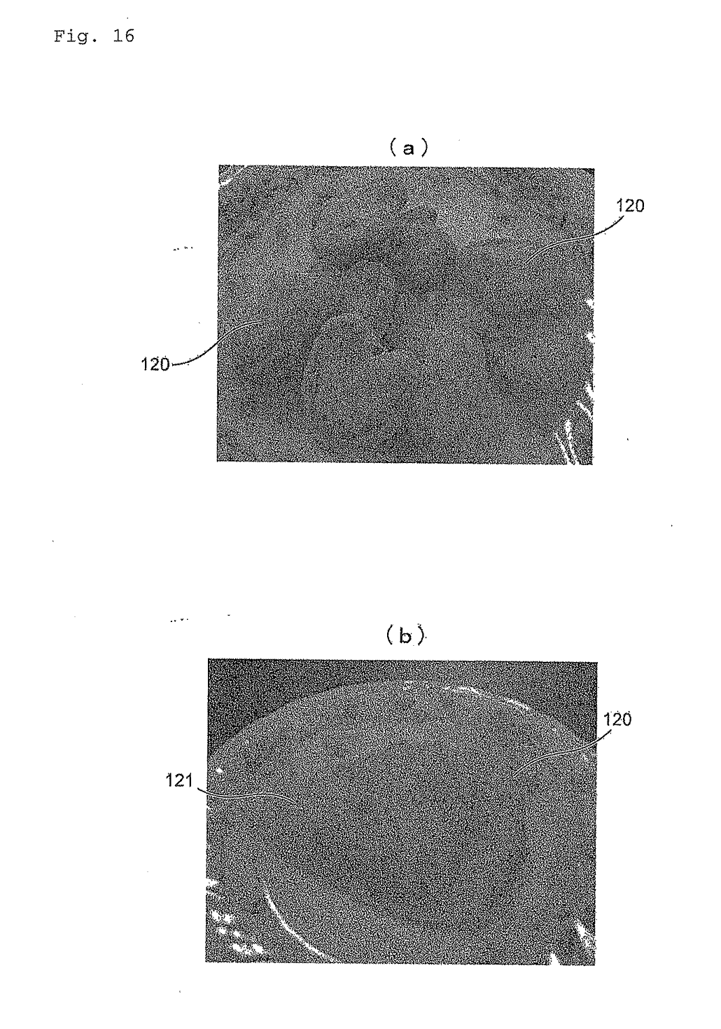

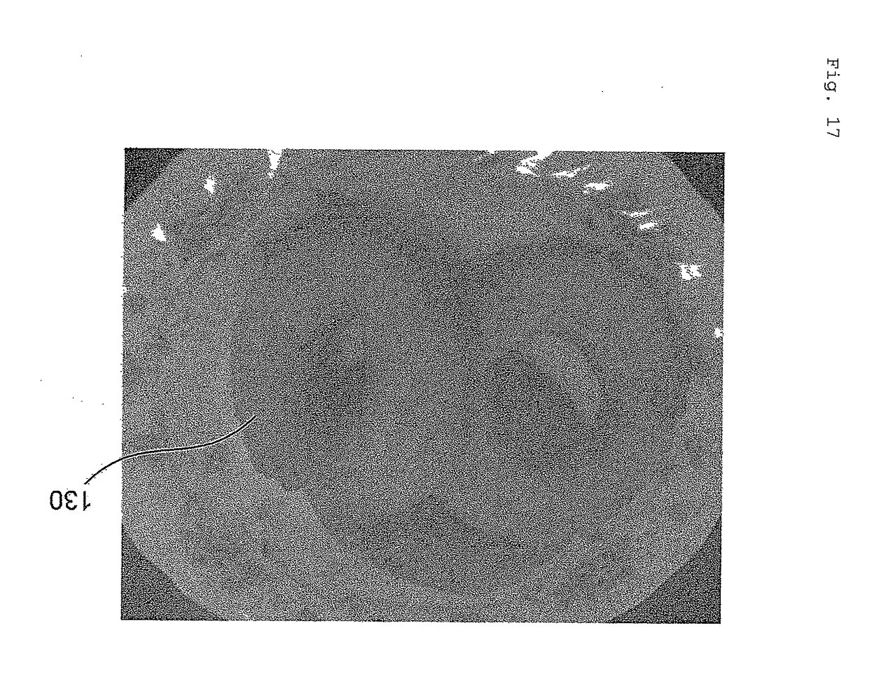

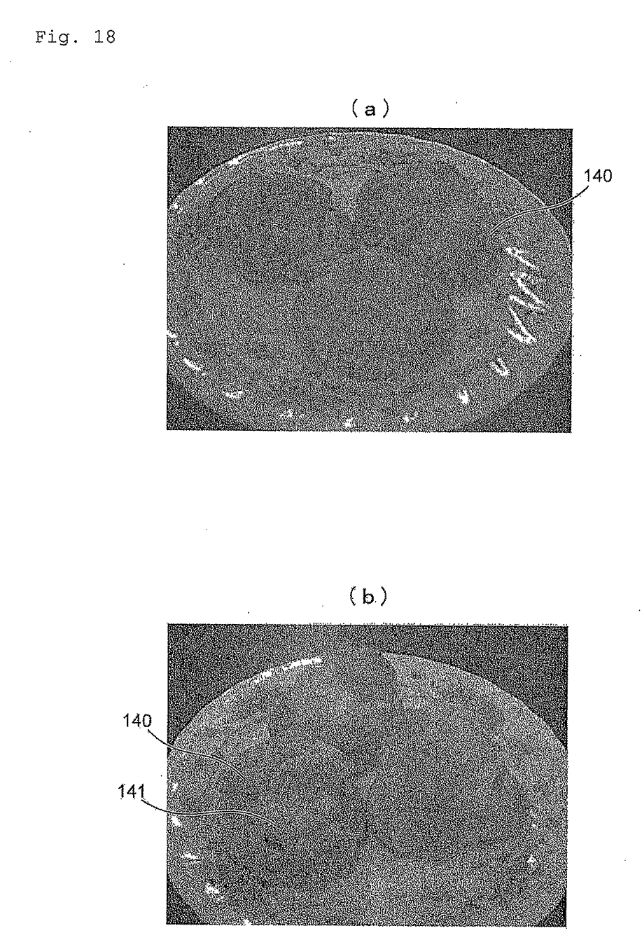

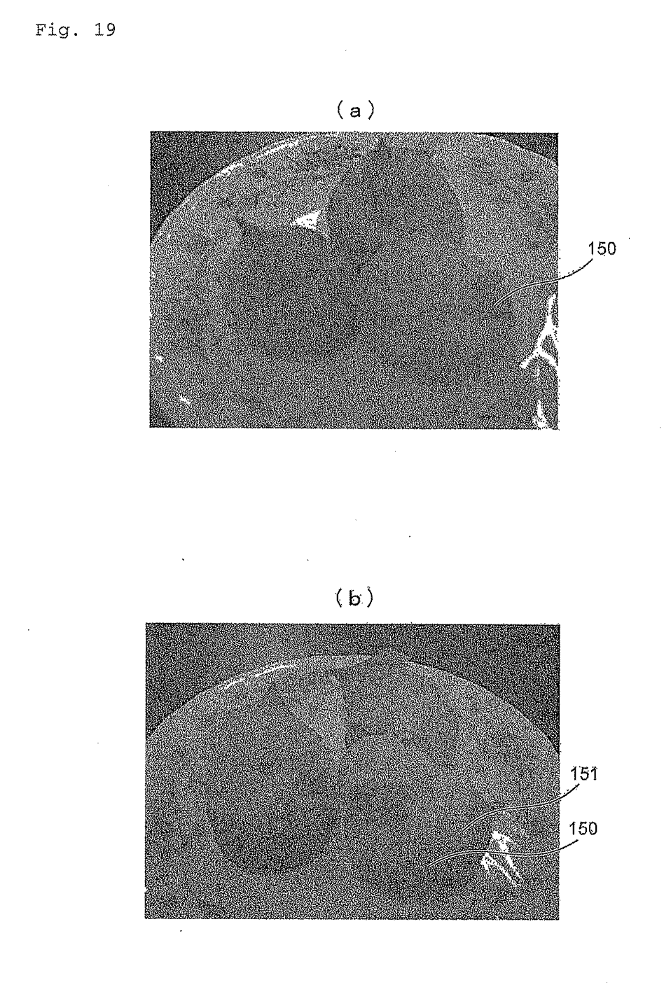

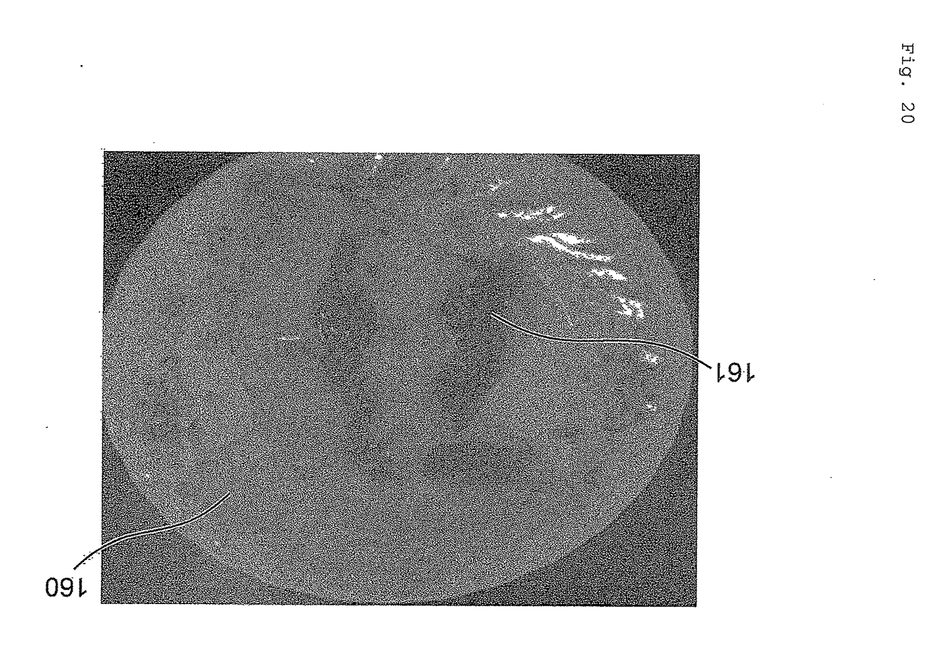

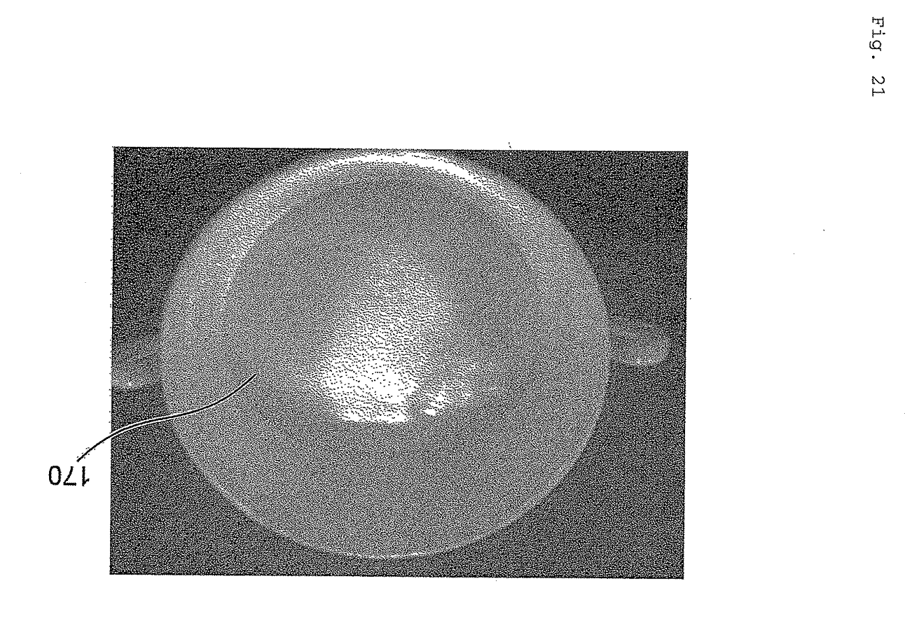

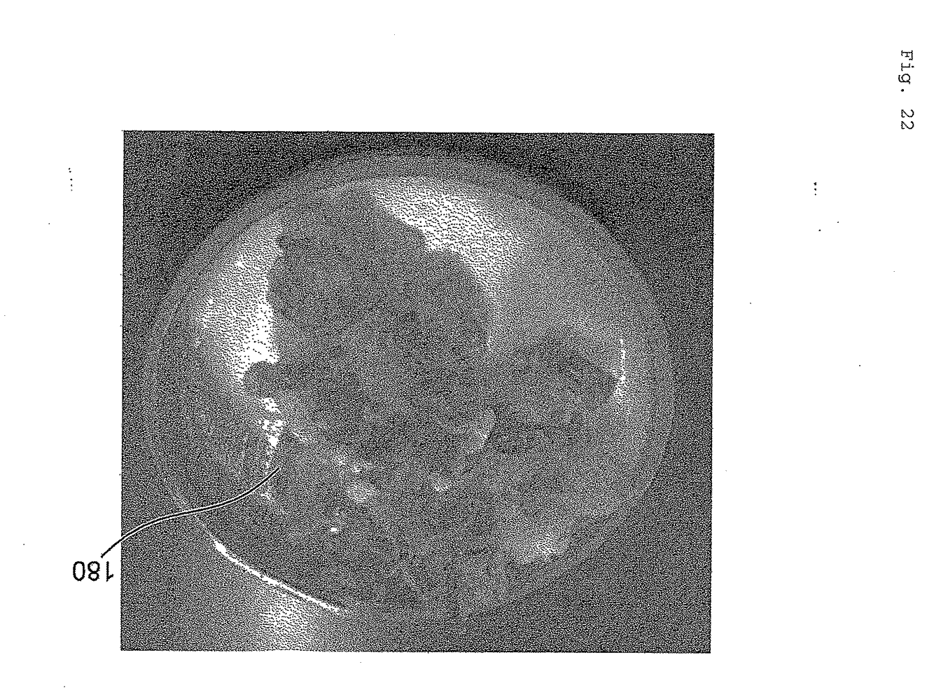

### BRIEF DESCRIPTION OF DRAWINGS

[FIG. 1] FIG. 1 is a process chart showing a method for production of a food material from rice as raw material and a method for production of a processed food using a food material from rice as raw material of the present invention.

[FIG. 2] FIG. 2 is a micrograph showing a rice paste and a micrograph showing rice flour milled by a conventional method.

[FIG. 3] FIG. 3 is a graph showing particle size distribution of finely-divided rice grains and rice flour milled by a conventional method, and a graph showing integrated values of the particle size distribution of the finely-divided rice grains.

[FIG. 4] FIG. 4 is a graph showing water absorption rate of finely-divided rice grains, and rice flour and bread flour.

[FIG. 5] FIG. 5 is a list of photographs showing a flow state and a spread state of a rice paste, a permeation state of free water to a filter paper and a distribution state of finely-divided rice grains.

[FIG. 6] FIG. 6 is a photograph showing the flow state of a rice paste.

[FIG. 7] FIG. 7 is a photograph showing the spread state of a rice paste.

[FIG. 8] FIG. 8 is a photograph showing the permeation state of free water contained in a rice paste to a filter paper.

[FIG. 9] FIG. 9 is a photograph showing the distribution state of finely-divided rice grains contained in a rice paste.

[FIG. 10] FIG. 10 is a graph showing hardness of rice grains in the case where the amount of water in which the rice grains are soaked is different.

[FIG. 11] FIG. 11 is micrographs showing surfaces of bread dough of Example 1, and Comparative Examples 1 and 2.

[FIG. 12] FIG. 12 is photographs showing surfaces and cross-sections of bread of Example 1, and Comparative Examples 1 and 2.

[FIG. 13] FIG. 13 is a table showing results of sensory evaluation on bread of Example 1 and Comparative Example 2.

[FIG. 14] FIG. 14 is a photograph showing a processed food as udon (Japanese wheat noodle) of Example 2.

[FIG. 15] FIG. 15 is a photograph showing a processed food as udon of Example 3.

[FIG. 16] FIG. 16 is a photograph showing a processed food as puff pastry of Example 4.

[FIG. 17] FIG. 17 is a photograph showing a processed food as a doughnut of Example 5.

[FIG. 18] FIG. 18 is a photograph showing a processed food as choux dough of Example 6.

[FIG. 19] FIG. 19 is a photograph showing a processed food as choux dough of Example 7.

[FIG. 20] FIG. 20 is a photograph showing a processed food as crepe dough of Example 8.

[FIG. 21] FIG. 21 is a photograph showing a processed food as white sauce of Example 9.

[FIG. 22] FIG. 22 is a photograph showing a processed food as a kakiage (Japanese fritter) of Example 10.

### DESCRIPTION OF EMBODIMENTS

Embodiments for carrying out the present invention will be shown below, and “a food material from rice as raw material” and “a processed food using a food material from rice as raw material” of the present invention will be explained together with a method for production thereof. Here, as for the following embodiments, it is able to appropriately make a modification within the range of the technical idea of the present invention.

### Food Material from Rice as Raw Material (See FIG. 1)

First, to explain the “food material from rice as raw material” according to the present invention, the food material is prepared by soaking rice grains 1 in water 2 to give a rice-grain soaked liquid 3 to allow the rice grains 1 to absorb water, thereafter charging the entire rice-grain soaked liquid 3 into a mill and milling the entire rice-grain soaked liquid 3, to give finely-divided rice grains 10 containing the water 2 absorbed therein, and the finely-divided rice grains form a rice paste 5 containing free water 20 among the finely-divided rice grains 10.

The breed of the rice grains 1 used as a raw material of this food material is preferably ssp. japonica, which is widespread in Japan, but may be ssp. indica or ssp. javanica.

In addition, the state of the rice grains 1 provided as a raw material may be at least rice grains of which chaff is removed, and may be either in a state of brown rice or in a state of polished rice. Needless to say, taking the form as a processed food into consideration, the state of polished rice is preferable, while the state of brown rice is preferable in order to comply with the demand of health trend. Furthermore, as the rice grains 1, those which were crushed (so-called crushed rice) can be also applied.

In addition, the “food material from rice as raw material” is a processed form of a rice paste 5, and rice grains 1 are soaked in water 2 before the processing, the ratio of the rice grains 1 to water 2 being 1:0.5 to 1.5 by weight.

Here, when considering that the food material is used as a material of bread 7 described below, it is more preferable that the rice grains 1: water is 1:0.8 to 1.2 by weight.

In addition, the rice grains 1 are soaked in water 2 for sufficient duration for the rice grains 1 to absorb water and to become able to be easily crushed, specifically 2 hours or more, and preferably 2 to 24 hours.

Incidentally, it has been confirmed that water 2 absorbed by the rice grains 1 becomes almost saturated in 2 hours of soaking.

In addition, temperature upon soaking may be room temperature, but it is preferable that the temperature is refrigeration temperature of around 5° C., when prevention of propagation of saprophytes is taken into consideration.

In addition, it is preferable that a mill-stone mill 8 is used for milling for processing rice grains 1 into a rice paste 5. Here, as for a preferable, commercially available apparatus, as an example, Supermasscolloider (MKCA6-2) manufactured by MASUKO SANGYO CO., LTD. and the like can be applied.

In this apparatus, millstones are stacked one on the other, and rice grains 1, which are untreated materials, are lead into the space between the millstones, to mill the rice grains 1 by rotation of the millstones so that the rice grains 1 are ground.

When charging the rice grains 1 to the mill-stone mill 8, the rice grains 1 are ensured to be charged thereto together with the entire water 2 used for soaking (the total amount of the rice-grain soaked liquid 3). Here, as for processing time by the action of the millstones, for example, in the case where the rotational speed of the millstones was 1,500 rpm, the total amount of the rice-grain soaked liquid 3 was emitted as a rice paste 5 in about 10 seconds to 2 minutes, when 1,400 g of the rice-grain soaked liquid 3 (700 g of rice+700 g of water) was charged from a hopper.

The rice grains 1 subjected to such a treatment become finely-divided rice grains 10 having a small particle size, and the particle size, though depending on the setting of the size of milling by the millstones, can be 1 to 10 μm as shown in FIG. 2(a), while the particle size of rice flour 11 prepared by general dry milling was about 30 μm as shown in FIG. 2(b).

Here, as shown in FIG. 3(a), it was confirmed that particle size distribution of the finely-divided rice grains 10 is concentrated in the range of 1 to 10 μm. Incidentally, a particle size of 5 μm is near the average particle size of starch (diameter of a starch simple grain), and it is thought that a starch aggregate 13 is disrupted into starch simple grain, which are minimum units, since free water 20 is involved so that fluidity is imparted to the starch aggregate 13, which was generated by destruction of starch cells 12 by the action of the mill-stone mill 8 so that the starch cells become in a state of fractions. This point will be examined later.

In addition, in FIG. 3(a), it is speculated that the secondary peak value near tens of micrometers indicates the starch aggregate 13 which was not disrupted, in which the finely-divided rice grains 10 having the particle size of about 1 to 10 μm clump.

Furthermore, as is clear from the integrated value of the particle size distribution of the finely-divided rice grains 10 shown in FIG. 3(b), it has been confirmed that those having a particle size of 10 μm or less account for 90% or more.

Now, results of comparison of the water absorption rate between the finely-divided rice grains 10 and rice flour 11 (prepared by general dry milling) are examined. In this examination, each of a rice paste 5 (15 g:6.8 g of finely-divided rice grains, 8.2 g of water) and rice flour 11 soaked in 8.2 g of water is subjected to centrifugation at 3,500 rpm for 30 minutes, thereafter the rates of moisture remaining in the finely-divided rice grains 10 and the rice flour 11 with respect to the weights of the finely-divided rice grains 10 and the rice flour 11 (water absorption rates) were calculated and the values are compared.

As a result, as shown in FIG. 4, it was confirmed that, while the water absorption rate of the finely-divided rice grains 10 was over 60%, the water absorption rate of the rice flour 11 was greatly different, being over 130%. Here, as reference data, the water absorption rate of commercially available bread flour (wheat flour) was over 90%.

Since it is known that the water absorption rate increases in the case of damaged starch, it is thought that the finely-divided rice grains 10 contained in the rice paste 5 are not damaged or only minimally damaged.

Furthermore, since the rice paste 5 still containing free water 20 among the finely-divided rice grains 10 containing water 2 absorbed therein, the finely-divided rice grains 10 can remain in a water-absorption state, and damage of the finely-divided rice grains 10 (starch simple grains) by drying becomes able to be avoided.

Next, comparison of properties of 5 kinds of rice pastes 5 was carried out by changing the ratio of the rice grains 1 and water 2. FIG. 5 is a list of photographs taken for confirming a flow state and a spread state of the rice paste 5, a permeation state of the free water 20 to a filter paper 9, and a distribution state of the finely-divided rice grains 10. In addition, photographs showing flow states of the rice pastes 5 are magnified and shown in FIG. 6. In addition, photographs showing spread states of the rice pastes 5 are magnified and shown in FIG. 7. In addition, photographs showing permeation states of the free water 20 contained in the rice paste 5 to a filter paper 9 are magnified and shown in FIG. 8. In addition, photographs showing distribution states of the finely-divided rice grains 10 contained in the rice paste 5 are magnified and shown in FIG. 9.

In the figures, as a rice paste 54 has a mixing ratio (weight ratio) of rice grains 1 and water 2 of 1:0.4, a rice paste 55 has a ratio of 1:0.5, a rice paste 56 of 1:0.6, a rice paste 57 of 1:0.7, and a rice paste 58 of 1:0.8. Here, these rice pastes 54 to 58 were obtained by setting the crushing conditions (time, rotational speed and the like) of the mill-stone mill 8 to be identical.

(1) Comparison of flow state (see FIG. 6)

The above-mentioned rice pastes 54 to 58 were scooped with a spoon, and the spoon was tilted to confirm flow states.

The rice pastes 54 and 55 did not flow down from the spoon, and thus a flow state was not confirmed. Here, the rice paste 54 did not become in a state of a paste, but in a state of being dry and unraveled.

Regarding the rice pastes 56, 57 and 58, flowing down from the spoon was observed and fluidity was confirmed.

(2) Comparison of spread state (see FIG. 7)

The above-mentioned rice pastes 54 to 58 were transferred to a plate, and a spread state was confirmed.

Spread (deformation) was not confirmed for the rice pastes 54 and 55.

Spread was confirmed to a small extent for the rice paste 56.

Spread was confirmed for the rice pastes 57 and 58.

(3) Comparison of a state of permeation to filter paper (see FIG. 8)

The above-mentioned rice pastes 54 to 58 were put onto a filter paper 9, and a state of permeation of water 2 (free water 20) to the filter paper 9 after 30 minutes was confirmed.

Permeation was not confirmed for the rice paste 54.

Permeation was confirmed for the rice pastes 55 to 58. Furthermore, it was confirmed that the radius of water 2 which permeated to the filter paper 9 was approximately proportional to the mixing ratio of water 2.

(4) Comparison of a state of distribution of finely-divided rice grains (see FIG. 9)

A state of distribution of finely-divided rice grains 10 for the above-mentioned rice pastes 54 to 58 was confirmed using a scanning electron microscope (1,000 times).

In the rice paste 54, a plurality of starch cells 12 and starch aggregates 13 were confirmed in addition to finely-divided rice grains 10.

In the rice paste 55, starch cells 12 and starch aggregates 13 were confirmed to a small extent in addition to finely-divided rice grains 10.

In the rice pastes 56 and 57, fine starch aggregates 13 were confirmed to a small extent in addition to finely-divided rice grains 10, and no starch cells 12 was confirmed.

In the rice paste 58, only finely-divided rice grains 10 were confirmed, and no starch cells 12 or no starch aggregate 13 was confirmed.

In addition, as shown in FIG. 10, hardness of the rice grains 1 was determined before the rice grains 1 were soaked in water 2 to give the rice pastes 54 to 58, and it was confirmed that hardness becomes approximately identical regardless of the amount of the water 2.

For this reason, it can be thought that the distribution situation (crushed state) of the finely-divided rice grains 10 did not depend on the hardness of the rice grains 1, but depended on the amount of the water 2 contained in the rice-grain soaked liquid 3.

Therefore, it is thought that, since the free water 20 is involved with the starch aggregate 13 wherein the starch cells 12 was disrupted by the action of the mill-stone mill 8 and became in a free state so that fluidity is imparted to the starch aggregate 13, the starch aggregate 13 was disrupted into starch simple grains, which are minimum units.

### Processed Food Using Food Material from Rice as Raw Material

The processed food of the present invention is obtained by mixing the above-mentioned food material from rice as raw material (the rice paste 5) with a different kind of cereal flour and/or other ingredients.

Now, a different kind of cereal flour is represented by flour prepared by milling wheat grains, and, in addition, so-called millet such as buckwheat, foxtail millet or Japanese millet can be used and may be further used in a mixture thereof.

In addition, the above-mentioned other ingredients include ingredients containing moisture such as water, an egg and cow milk; salt; sugar; butter; a puffing agent; and the like.

The mixture of the food material from rice as raw material (the rice paste 5) and a different kind of cereal flour and/or other ingredients is appropriately shaped into a state suitable for eating, and further heated, if needed, to an edible state, to be provided in the market. Needless to say, final heating operation may be carried out by a consumer as a part of cooking.

Here, those shaped into a state suitable for eating and provided in the market include: noodles such as udon and buckwheat noodle; and the like, and those provided in the market in an edible state include: bread; a doughnut; baked goods such as choux, a crepe, a cookie and a biscuit; white sauce; and the like.

In addition, as for the above-mentioned heating, baking with an oven or the like is carried out in the case of bread, baked goods and the like, and steaming with boiling water, steam or the like is carried out in the case of noodles; and a frying treatment with cooking oil may be further carried out.

Furthermore, the food material from rice as raw material (the rice paste 5) can also be used as batter of a tempura or a fry.

### Processed Food as Bread (See FIG. 1)

Next, a processed food as bread 7, which is a typical use, will be explained.

First, in a preparation step of bread dough 6, wheat flour (bread flour) is used as a different kind of cereal flour, and finely-divided rice grains 10 are mixed therewith so that the rate of substitution for the wheat flour is 10 to 50%, preferably 20 to 40%.

Here, when mixing the both, wheat flour, yeast and seasonings are first kneaded with water added thereto (as an example, for 2 minutes) to prepare a kneaded product 60. Here, the amount of water at this time is set to be smaller than a usual amount, taking the amount of water 2 contained in the rice paste 5 into consideration.

Next, by adding the rice paste 5 to the kneaded product 60 and kneading the mixture (as an example, for 8 minutes), bread dough 6 is prepared.

At this time, since moisture required for gelatinization of rice components has been already absorbed by the finely-divided rice grains 10 and does not affect gluten formation of wheat flour, gluten formation become able to be successfully carried out. Furthermore, since the rice paste 5 of which affinity is improved by free water 20 is rapidly mixed thoroughly and evenly with the wheat flour which has been previously kneaded, binding of rice starch particles 30 to gluten can be successfully carried out.

Thereafter, this bread dough 6 is appropriately fermented and appropriately further shaped, and thereafter baked and puffed to be processed into bread 7.

Incidentally, steps from fermentation to baking of the bread dough 6 follow conventional methods.

### Processed Food as Noodle

Next, a case where a form of noodle is taken as a processed food using a food material from rice as raw material will be explained. Regarding kinds of noodles, taking forms of udon, Chinese noodles, buckwheat noodle and the like, in this case, finely-divided rice grains 10 are mixed with wheat flour or the like as a main raw material so that the rate of substitution of the finely-divided rice grains 10 for the wheat flour is 20 to 80%.

Here, each method for production basically follows a processing method of each noodle.

### Processed Food as Baked Goods

Next, a case where a form of baked goods is taken as a processed food using a food material from rice as raw material will be explained. Regarding kinds of baked goods, taking forms of pie, choux, a crepe, a cookie, a biscuit and the like, in this case, finely-divided rice grains 10 are also mixed with wheat flour or the like as a main raw material so that the rate of substitution of the finely-divided rice grains 10 for the wheat flour is 20 to 100%.

Here, each method for production basically follows a processing method of each of the baked goods.

### Examples

### Example 1: Processed Food as Bread

Example 1, which is a processed food as bread 7, will be hereinafter illustrated.

In this Example 1, finely-divided rice grains 10 substitute for substantially 30% of wheat flour, and the composition of each ingredient was set as follows.

wheat flour: 210 g

sugar: 20 g

salt: 5 g

skim milk: 5 g

yeast: 3 g

butter: 20 g

water: 92 g

rice paste: 198 g (finely-divided rice grains:water=1:1.2, finely-divided rice grains: 90 g, water: 108 g)

### Comparative Example 1

As Comparative Example 1, bread having the following general composition of each ingredient was prepared.

wheat flour: 300 g

sugar: 20 g

salt: 5 g

skim milk: 5 g

yeast: 3 g

butter: 20 g

water: 200 g

### Comparative Example 2

As Comparative Example 2, bread wherein 30% of wheat flour is substituted by rice flour (dry-milled and having particle size of about 30 μm) was prepared. Composition of each ingredient was set as follows.

wheat flour: 210 g

sugar: 20 g

salt: 5 g

skim milk: 5 g

yeast: 3 g

butter: 20 g

water: 200 g

rice flour: 90 g (rice flour was prepared by dry milling)

First, comparison in a state of bread dough 6 was carried out by observation with a scanning electron microscope (1,000 times).

What is shown in FIG. 11(a) is a magnified surface of Example 1, what is shown in (b) is a magnified surface of Comparative Example 1, and what is shown in (c) is a magnified surface of Comparative Example 2.

In Comparative Example 1, streaky gluten 61 was clearly observed.

In Example 1, it was confirmed that a rice starch particle 30 was in a state that the particle was stuck into (binding to) streaky gluten 61.

In Comparative Example 2, although a rice starch particle 30 was observed, streaky gluten 61 was not observed.

Next, comparison in a state of bread 7 which was prepared by baking and puffing the above-mentioned bread dough 6 under the same conditions was visually carried out.

What is shown in FIG. 12(a) is a photograph of the front side and a cross-section of Example 1, what is shown in (b) is a photograph of the front side and a cross-section of Comparative Example 1, and what is shown in (c) is a photograph of the front side and a cross-section of Comparative Example 2.

Using Comparative Example 1 as a base, it was confirmed that Example 1 is puffed to the same extent as Comparative Example 1, and it was also confirmed that the state of air bubbles 70, so-called fineness in texture, was comparable.

On the other hand, as for Comparative Example 2, using Comparative Example 1 as a base, it was confirmed that the puffing remained at about 70%. In addition, it was confirmed that the state of air bubbles 70, so-called fineness in texture, had become coarse.

Next, Example 1, Comparative Example 1, and Comparative Example 2 were actually eaten, to carry out sensory evaluation on texture and the like. As a result, as shown in FIG. 13, although Example 1 is slightly inferior in the item of “uniformity of texture” as compared with Comparative Example 1, results which are better than those of Comparative Example 1 were obtained in all of other items.

On the other hand, Comparative Example 2 had inferior results in all of the items as compared with Comparative Example 1.

As a result, it was confirmed that Example 1 is clearly more excellent than Comparative Example 2, which contains the same amount of rice components.

### Example 2: Processed Food as Udon

Next, Example 2, which is a processed food as udon, will be illustrated.

In this Example 2, finely-divided rice grains substitute for substantially 50% of wheat flour, and the composition of each ingredient was set as follows.

wheat flour: 50 g

salt: 1.5 g

water: 10 g

rice paste: 100 g (finely-divided rice grains:water=1:1, finely-divided rice grains: 50 g, water: 50 g)

First, wheat flour, salt and water are added to a rice paste, and the mixture is well kneaded. Thereafter, the kneaded product is let stand for 30 minutes or more, and the dough is rolled out and thinly cut. The cut dough is boiled in boiling water for about 10 minutes and thereafter immersed in ice water, to give udon 100, which is a processed food in an edible state (see FIG. 14).

The processed food as udon 100 thus produced was confirmed to have texture, body, taste and the like which were comparative to those of a product made from original ingredients.

### Example 3: Processed Food as Udon

Next, Example 3, which is a processed food as udon of which mixed amount of a rice paste is different, will be illustrated.

In this Example 3, finely-divided rice grains substitute for substantially 71.4% of wheat flour, and the composition of each ingredient was set as follows.

wheat flour: 20 g

salt: 1.5 g

rice paste: 100 g (finely-divided rice grains:water=1:1, finely-divided rice grains: 50 g, water: 50 g)

First, wheat flour and salt are added to a rice paste, and the mixture is well kneaded. Thereafter, the kneaded product is let stand for 30 minutes or more, and the dough is rolled out and thinly cut. The cut dough is boiled in boiling water for about 10 minutes and thereafter immersed in ice water, to give udon 110, which is a processed food in an edible state (see FIG. 15),

The processed food as udon 110 thus produced was confirmed to have texture, body, taste and the like which were comparative to those of a product made from original ingredients, as in the case with Example 2.

### Example 4: Processed Food as Puff Pastry

Next, Example 4, which is a processed food as puff pastry, will be illustrated.

In this Example 4, finely-divided rice grains substitute for substantially 82% of wheat flour, and the composition of each ingredient was set as follows.

bread flour: 20 g

butter: 90 g

flour for dusting: a little

rice paste: 180 g (finely-divided rice grains:water=1:1, finely-divided rice grains: 90 g, water: 90 g)

Dough is gathered with adding bread flour to rice paste a little at a time, and put onto a work surface sprinkled with flour for dusting. Next, butter cut into 2 cm cubes are put onto the center of the dough and mixed therewith little by little, and the entire mixture is quickly gathered, when the dough is almost mixed.

Next, flour for dusting is sprinkled on the work surface, and the dough is rolled out into a rectangle with rolling a rolling pin from right to left and up and down, thereafter folded into 3 layers. Next, the dough is wrapped with plastic wrap sprinkled with flour for dusting, and let stand in a refrigerator for about 60 minutes. Furthermore, such rolling out and letting stand are repeated a plurality of times, and the dough is rolled out and shaped into the size of a pie plate.

By placing ingredients 121 onto the pastry, applying yolk on the surface of the pastry and baking the pastry in an oven at 180 to 200° C. for 25 to 30 minutes, puff pastry 120, which is a processed food in an edible state, is prepared (see FIG. 16).

The processed food as puff pastry 120 thus produced was confirmed to have texture, taste and the like which were comparative to those of a product made from original ingredients.

Incidentally, as the above-mentioned ingredients 121, 300 g of apples and 90 g of sugar were used.

### Example 5; Processed Food as Doughnut

Next, Example 5, which is a processed food as a doughnut, will be illustrated.

In this Example 5, finely-divided rice grains substitute for substantially 43% of wheat flour, and the composition of each ingredient was set as follows.

wheat flour: 20 g

butter: 10 g

sugar: 10 g

entire egg: 7 g

baking powder: 0.5 g

frying oil: a little

rice paste: 30 g (finely-divided rice grains:water=1:1, finely-divided rice grains: 15 g, water: 15 g)

Butter is put into a bowl and well kneaded, to which sugar is added, and the mixture is further kneaded. Next, entire egg is added thereto and the mixture is further mixed with attention not to separate the mixture and the entire egg. Next, a rice paste and sifted wheat four are added thereto, and the entire mixture is well mixed. Next, the dough is sprinkled with flour for dusting and rolled out, and shaped using a doughnut cutter. By frying the dough in oil at about 160° C. until golden brown, a doughnut 130, which is a processed food in an edible state, is prepared (see FIG. 17).

The processed food as the doughnut 130 thus produced was confirmed to have texture, taste and the like which were comparative to those of a product made from original ingredients.

### Example 6: Processed Food as Choux Dough

Next, Example 6, which is a processed food as choux dough, will be illustrated.

In this Example 6, finely-divided rice grains substitute for substantially 82% of wheat flour, and the composition of each ingredient was set as follows.

wheat flour: 10 g

butter: 25 g

salt: 0.5 g

entire egg: 60 g

rice paste: 30 g (finely-divided rice grains:water=1:1, finely-divided rice grains: 15 g, water: 15 g)

Butter is put into a pan and heated, and, when the butter boils, wheat flour is added thereto and mixed, avoiding clumping, thereafter the pan is removed from heat.

Thereafter, when the entire mixture become gathered, a rice paste is added thereto, and, when the mixture is uniformly mixed, the mixture is heated again and appropriately heated, thereafter removed from heat, to which entire egg is added.

By putting the dough into a pastry bag, squeezing the dough onto a baking sheet for an oven, baking the dough at 180 to 200° C. for 15 minutes and further baking the dough for about 5 minutes with lowering the temperature to 160 to 180° C., choux dough 140, which is a processed food in an edible state, is prepared (see FIG. 18).

Thereafter, cream 141 which has been separately prepared is injected into the choux dough 140.

The processed food as the choux dough 140 thus produced was confirmed to have texture, taste and the like which were comparative to those of a product made from original ingredients.

Incidentally, as the above-mentioned cream 141, custard cream was used.

### Example 7: Processed Food as Choux Dough

Next, Example 7, which is a processed food as choux dough of which blended amount of rice paste is different, will be illustrated.

In this Example 7, finely-divided rice grains substitute for substantially 100% of wheat flour, and the composition of each ingredient was set as follows.

wheat flour: 0 g

butter: 25 g

salt: 0.5 g

entire egg: 30 g

rice paste: 50 g (finely-divided rice grains:water=1:1, finely-divided rice grains: 25 g, water: 25 g)

Butter is put into a pan and heated, and, when the butter boils, the pan is removed from heat.

Next, a rice paste is added thereto, and, when the mixture is uniformly mixed, the mixture is heated again and appropriately heated, and thereafter removed from heat, to which entire egg is added.

By putting the dough into a pastry bag, squeezing the dough onto a baking sheet for an oven, baking the dough at 180 to 200° C. for 15 minutes and further baking the dough for about 5 minutes with lowering the temperature to 160 to 180° C., choux dough 150, which is a processed food in an edible state, is prepared (see FIG. 19).

Thereafter, cream 151 which has been separately prepared is injected into the choux dough 150.

The processed food as the choux dough 150 thus produced was confirmed to have texture, taste and the like which were comparative to those of a product made from original ingredients, as in the case with the choux dough in Example 6.

Incidentally, as the above-mentioned cream 151, custard cream was used.

### Example 8: Processed Food as Crepe Dough

Next, Example 8, which is a processed food as crepe dough, will be illustrated.

In this Example 8, finely-divided rice grains substitute for substantially 100% of wheat flour, and the composition of each ingredient was set as follows.

wheat flour: 0 g

sugar: 5 g

entire egg: 20 g

cow milk: 50 cc

salad oil: appropriate amount

rice paste: 50 g (finely-divided rice grains:water 1:1, finely-divided rice grains: 25 g, water: 25 g)

Entire egg is put into a bowl and mixed with a whisk, to which sugar is added, and the mixture is further mixed, thereafter, cow milk is then added thereto. Next, by adding a rice paste thereto, greasing a heated frying pan when the mixture is uniformly mixed, and baking the both sides of the dough with thinly rolling out the dough, crepe dough 160, which is a processed food in an edible state, is prepared (see FIG. 20).

Thereafter, toppings 161 which were separately prepared such as jam, honey and the like are placed onto the dough.

The processed food as the crepe dough 160 thus produced was confirmed to have texture, taste and the like which were comparative to those of a product made from original ingredients.

### Example 9: Processed Food as White Sauce

Next, Example 9, which is a processed food as white sauce, will be illustrated.

In this Example 9, finely-divided rice grains substitute for substantially 100% of wheat flour, and the composition of each ingredient was set as follows.

wheat flour: 0 g

butter: 10 g

cow milk: 170 cc

salt and pepper: a little

rice paste: 25 g (finely-divided rice grains:water=1:1, finely-divided rice grains: 12.5 g, water: 12.5 g)

Butter is put into a pan and heated, to which a rice paste is added, and the mixture is uniformly mixed. Cow milk is added thereto a little at a time to dilute the mixture, and thereafter the mixture is heated over a medium heat and, after the mixture reaches an appropriate thickness, simmered for a while. Finally, by tasting the mixture with salt and pepper, white sauce 170, which is a processed food in an edible state, is prepared (see FIG. 21).

Thereafter, the white sauce 170 was served as a gratin by baking the white sauce with ingredients which were separately prepared, or as sauce for pasta and the like.

The processed food as the white sauce 170 thus produced was confirmed to have texture, taste and the like which were comparative to those of a product made from original ingredients.

### Example 10: Processed Food as Kakiage

Next, Example 10, which is a processed food as a kakiage, will be illustrated.

In this Example 10, finely-divided rice grains substitute for substantially 100% of wheat flour, and the composition of each ingredient was set as follows.

wheat flour: 0 g

dried shrimps

(Sergia lucens): 5 g

egg: 10 g

Japanese leek: 25 g

frying oil: a little

rice paste: 70 g (finely-divided rice grains:water=1:1, finely-divided rice grains: 35 g, water: 35 g)

A rice paste and egg are put into a bowl, and well mixed. Next, dried shrimps and Japanese leek cut into 1 cm in length are added thereto, and the mixture is mixed. Thereafter, by frying the mixture in oil at about 180° C. so that mixture is cooked to the center, a kakiage 180, which is a processed food in an edible state, is prepared (see FIG. 22).

The processed food as the kakiage 180 thus produced was confirmed to have texture, taste and the like which were comparative to those of a product made from original ingredients.

Here, some of the micrographs and the like shown in the figures of the present application are difficult to discriminate, since the micrographs and the like are presented in black and white having no intermediate gradation, on the basis of the specification for international patent application. On the other hand, in a document related to Japanese Patent Application No. 2010-010858 (filing date: Jan. 21, 2010) filed with Japan Patent Office, which application is a base of the priority of the present application, a gray scale format in which intermediate gradation is maintained is used.

Thus, as for the micrographs and the like which are difficult to discriminate in the drawings of the present application, it is able to discriminate the micrographs and the like by referring to the document related to the patent application filed with Japan Patent Office.

### REFERENCE SIGNS LIST

1 rice grains

10 finely-divided rice grains

11 rice flour

12 starch cells

13 starch aggregate

2 water

20 free water

3 rice-grain soaked liquid

30 rice starch particle

5 rice paste

54 rice paste

55 rice paste

56 rice paste

57 rice paste

58 rice paste

6 bread dough

60 kneaded product

61 gluten

7 bread

70 air bubbles

8 mill-stone mill

9 filter paper

100 udon

110 udon

120 puff pastry

121 ingredients

130 doughnut

140 choux dough

141 cream

150 choux dough

151 cream

160 crepe dough

161 toppings

170 white sauce

180 kakiage

1. A food material from rice as raw material, wherein rice grains are soaked in water to give a rice-grain soaked liquid to allow the rice grains to absorb water and the entire rice-grain soaked liquid is then charged into a mill to mill the rice grains to prepare finely-divided rice grains containing water absorbed therein and wherein the finely-divided rice grains form a rice paste containing free water present therebetween, thereby keeping the water-absorption state of the finely-divided rice grains.

2. The food material from rice as raw material according to claim 1, wherein a ratio of the rice grains to water is 1:0.5 to 1.5 by weight.

3. The food material from rice as raw material according to claim 1, wherein the maximum particle size distribution peak of the finely-divided rice grains which are milled rice grains contained in the rice paste is from 1 to 10 μm.

4. A processed food using a food material from rice as raw material, wherein a rice paste according to claim 1, is mixed with a different kind of cereal flour and/or other ingredients, further the mixture is shaped appropriately into a state suitable for eating.

5. A processed food using a food material from rice as raw material, wherein a rice paste according to claim 1, is mixed with a different kind of cereal flour and/or other ingredients, further the mixture is shaped appropriately into a state suitable for eating and further heated to become an edible state.

6. The processed food using a food material from rice as raw material according to claim 4, wherein the different kind of cereal flour is wheat flour and the processed food is bread.

7. The processed food using a food material from rice as raw material according to claim 6, wherein a rate of substitution of the finely-divided rice grains for the wheat flour is 10 to 50%.

8. A method for production of a food material from rice as raw material, wherein rice grains are soaked in water to give a rice-grain soaked liquid to allow the rice grains to absorb water and the entire rice-grain soaked liquid is then charged into a mill to mill the rice grains to prepare finely-divided rice grains containing water absorbed therein and wherein the finely-divided rice grains form a rice paste containing free water present therebetween, thereby keeping the water-absorption state of the finely-divided rice grains.

9. The method for production of a food material from rice as raw material according to claim 8, wherein a ratio of water for soaking the rice grains to the rice grains is 1:0.5 to 1.5 by weight.

10. The method for production of a food material from rice as raw material according to claim 8, the rice grains are soaked in the water for 2 hours or more.

11. The method for production of a food material from rice as raw material according to claim 8, wherein the milling is carried out with a mill-stone mill.

12. A method for production of a processed food using a food material from rice as raw material, wherein a rice paste according to claim 1, is kneaded with a different kind of cereal flour and/or other ingredients, and the mixture is appropriately shaped into a state suitable for eating.

13. A method for production of a processed food using a food material from rice as raw material, wherein a rice paste according to claim 1, is kneaded with a different kind of cereal flour and/or other ingredients, and the mixture is appropriately shaped into a state suitable for eating, and further heated to become an edible state.

14. A method for production of a processed food using a food material from rice as raw material, wherein a rice paste according to claim 1, wheat flour, an appropriate amount of yeast added for producing bread dough, and a seasoning are prepared, and the wheat flour, the yeast and the seasoning are first kneaded with water added therein, subsequently the rice paste is added therein and the mixture is kneaded to prepare bread dough, and the bread dough is thereafter baked and puffed to be processed into bread.

15. The method for production of a processed food using a food material from rice as raw material according to claim 14, wherein a rate of substitution of the finely-divided rice grains for the wheat flour is 10 to 50%.
